(19) United States
(12) Patent Application Publication
(10) Pub. No.: US 2002/0150024 A1
(43) Pub. Date: Oct. 17, 2002

(54) Optical head apparatus

(76) Inventors: Katsuya Moriyama, Nagano (JP); Hisahiro Ishihara, Nagano (JP); Masao Takemura, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 10/116,667

(22) Filed: Apr. 3, 2002

(30) Foreign Application Priority Data
Apr. 12, 2001 (JP) 2001-114413

(51) Int. Cl. G11B 7/00; G11B 17/00; G11B 21/16

(52) U.S. Cl. 369/247; 369/44.16

(57) ABSTRACT

An optical head apparatus includes a wiring substrate and an apparatus frame that is made of a resin or another damper material. Optical components that form an optical system are mounted on the wiring substrate. On the other hand, components such as wire suspensions and yoke plate of an object lens driving mechanism, which is a source of vibration, are mounted on the apparatus frame. The apparatus frame is attached to the surface of the wiring substrate. Vibration that may be generated in the object lens driving mechanism is absorbed by the apparatus frame having a damper function, and therefore do not transfer to the optical components mounted on the wiring substrate.

### BACKGROUND OF THE INVENTION

1. Field of the Invention

The present invention relates to an optical head apparatus that is used to reproduce data on optical recording disks such as CDs (compact disks), DVDs (digital versatile disks) and the like.

2. Description of Related Art

Optical head apparatuses, a key part in reproduction equipment used to reproduce data on optical recording disks, have become increasingly smaller and thinner as notebook PCs have become popular and demands on portable reproduction equipment have grown. One way that has been suggested to make optical head apparatuses smaller and thinner is to use wiring substrates of optical head apparatuses as apparatus frames on which to mount optical parts and other components.

Unlike structures in which components are mounted on a thick apparatus frame made of aluminum or resin, when components are mounted on a thin wiring substrate, the following problem can occur. When a vibration generating part such as an object lens drive mechanism is mounted on the thin wiring substrate, the vibration generated is transmitted to optical system components mounted on the wiring substrate and causes these components to vibrate. When the vibration is transmitted to a laser diode and/or a light receiving element in particular, optical properties of the optical system suffer significantly, which deteriorates the optical properties of the optical system.

In order to prevent such a harmful effect, when an object lens drive apparatus and optical system components are mounted on a flat panel, a slit may be formed in the flat panel between a section on which the object lens drive mechanism is mounted and a section on which the optical parts are mounted, thereby preventing the transmission of vibration.

However, when a slit is formed in a wiring substrate that is thin and tends to lack rigidity, the rigidity of the wiring substrate diminishes significantly and its space for mounting components as well as the space for wiring are diminished, which would not be desirous.

### SUMMARY OF THE INVENTION

In view of the above, the present invention relates to an optical head apparatus that uses a wiring substrate as a substrate to mount components thereon, and more particularly to an optical head apparatus that prevents vibration generated by an object lens drive mechanism from being transmitted to optical parts without diminishing the rigidity of the wiring substrate or reducing its space for mounting components and/or wiring.

In accordance with an embodiment of the present invention, an optical head apparatus may include a light source, a lens holder to hold an object lens that converges light emitted from the light source onto an optical recording medium, a holder support member that supports the lens holder in a manner movable in at least one of a focusing direction and a tracking direction, a light receiving element that receives light returning from the optical recording medium, and a plurality of optical parts that constitute an optical system that leads the light emitted from the light source towards the object lens while also leading the light returning from the optical recording medium towards the light receiving element, wherein the light source, the light receiving element, and at least one of the optical parts are mounted on a wiring substrate on which is formed a power feed wiring pattern for the light source and for the light receiving element, and the holder support member is attached to the wiring substrate via a damper member.

In accordance with the embodiment of the present invention, since the holder support member is attached to the wiring substrate via the damper member, vibration generated in the holder support members is absorbed by the damper member and is not transmitted to the wiring substrate side. As a result, even if vibration were to be generated from the drive of the object lens drive mechanism situated between the lens holder and the holder support member, harmful effects resulting from the vibration, i.e., optical parts mounted on the wiring substrate caused to vibrate and the optical properties of the optical system consequently deteriorating, can be avoided.

Here, the damper member may be an apparatus frame equipped with a bearing section that can slide along a primary shaft or a secondary shaft bridged in the radial direction of the optical recording medium.

In this case, in a preferred embodiment, the apparatus frame may be made of resin. The resin apparatus frame can enhance the anti-vibration effect.

In addition, a vibration absorbing material storage section may be formed on the apparatus frame to store a vibration absorbing material and thereby give a damper function to the frame.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows a cross-sectional view of an optical head apparatus in accordance with one embodiment of the present invention.

FIG. 2 shows an exploded perspective view of the optical head apparatus shown in FIG. 1.

FIG. 3 shows a perspective view of a light receiving/emitting element of the optical head apparatus shown in FIG. 1.

FIG. 4 shows a perspective view of an optical system of the optical head apparatus shown in FIG. 1.

FIG. 5 shows a process diagram showing a procedure of assembling an optical head apparatus.

FIG. 6 is an illustrative drawing showing a method of forming a semiconductor laser chip-positioning member in the light receiving/emitting element of the optical head apparatus.

FIG. 7 is an illustrative drawing showing a method of positioning a semiconductor laser chip of the light receiving/emitting element of the optical head apparatus.

FIG. 8 shows an exploded perspective view showing a method of mounting optical parts on the wiring substrate of the optical head apparatus.

FIG. 9 shows an exploded perspective view of a modified embodiment of the optical head apparatus shown in FIG. 1.

FIG. 10 shows an exploded perspective view of still another modified embodiment of the optical head apparatus shown in FIG. 1.

### PREFERRED EMBODIMENTS OF THE INVENTION

An optical head apparatus in accordance with an embodiment of the present invention will be described with reference to the accompanying drawings.

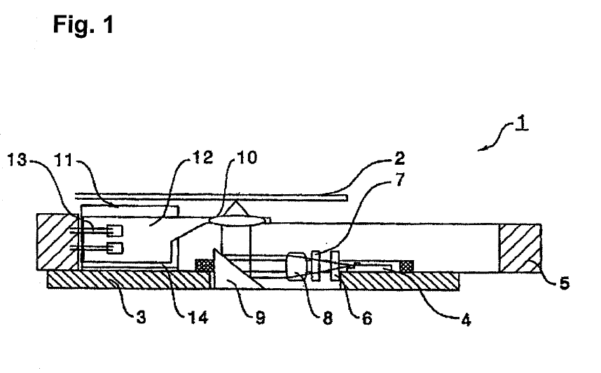

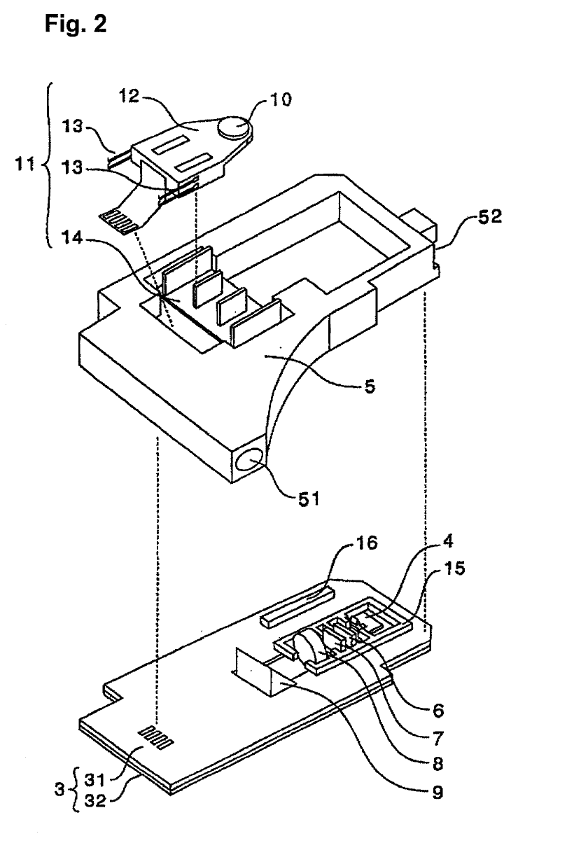

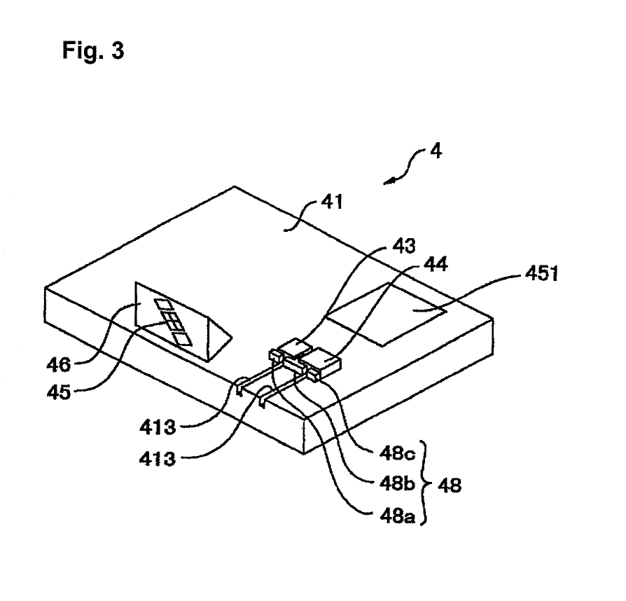

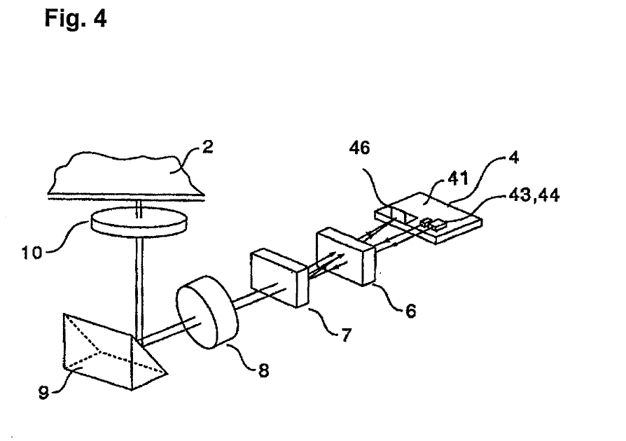

FIG. 1 is a cross-sectional view showing an optical head apparatus according to the embodiment of the present invention. FIG. 2 is an exploded perspective view of the optical head apparatus shown in FIG. 1. FIG. 3 is a perspective view of a light receiving/emitting element of the optical head apparatus shown in FIG. 1. FIG. 4 is a perspective view of an optical system of the optical head apparatus in FIG. 1.

Referring to these drawings, an optical head apparatus 1 according to the present embodiment is a dual wavelength optical head apparatus that uses one laser beam with a wavelength of 650 nm band and another laser beam with a wavelength of 780 nm band to record information on to and reproduce information from an optical recording medium 2 such as a CD or a DVD. The optical head apparatus 1 has a wiring substrate 3 and an apparatus frame 5 laminated and fixed on the surface of the wiring substrate 3, and various components of the optical head apparatus 1 are mounted on these two elements.

A light receiving/emitting element 4, first and second optical elements 6 and 7, a collimate lens 8 and a raising mirror 9 are mounted on the wiring substrate 3. On the other hand, components of an object lens drive mechanism 11 to move an object lens 10 in a tracking direction and/or a focusing direction are mounted on the apparatus frame 5. The apparatus frame 5 may preferably be made of a resin that can adequately absorb vibrations of the object lens drive mechanism 11.

The object lens drive mechanism 11 is equipped with a lens holder 12 that holds the object lens 10, wire suspensions 13 (holder support members) that support the lens holder 12 to be movable in the tracking direction and/or the focusing direction, and a magnetic drive mechanism that generates magnetic force to move the lens holder 12 in the tracking direction and/or the focusing direction. The magnetic drive mechanism includes a drive magnet (not shown in the figure) attached to a yoke plate 14, which is fixed on to the apparatus frame 5, and a drive coil (not shown in the figure) attached to the lens holder 12.

The apparatus frame 5 may generally have a frame shape having a cut out section, and the object lens drive mechanism 11 may be mounted inside the cut out section of the apparatus frame 5, as shown in FIG. 1. In the example shown in FIG. 1, the yoke plate 14 with the drive magnet is attached inside the cut out section of the apparatus frame 5, and the wire suspensions 13 that moveably support the lens holder 12 in a cantilever fashion are connected to one inner wall of the cut out section of the apparatus frame 5.

The wiring substrate 3 according to the present embodiment has a laminated structure comprising a wiring plate section 31 and a metal base plate section 32. On the wiring plate section 31 is mounted a component holder 15 that is frame-shaped and that positions various components. The light receiving/emitting element 4, the first optical element 6, the second optical element 7, the collimate lens 8 and the raising mirror 9 are held and fixed on the component holder 15. Further, a connector 16 to connect with external wiring, as well as a wiring pattern to supply power to the light receiving/emitting element 4 and to a drive coil of the magnetic drive mechanism are mounted on the surface of the wiring panel 3.

In contrast, the apparatus frame 5 is made of resin, and at its two ends are formed a primary shaft guide hole 51 and a secondary shaft guide groove 52. The primary shaft guide hole 51 and the secondary shaft guide groove 52 are both mounted in a freely sliding manner on a primary shaft and a secondary shaft, respectively, that are placed on the sides of the main body of a recording/reproduction apparatus into which the optical head apparatus 1 will be assembled, so that the entire optical head apparatus 1 can move back and forth in a radial direction of the optical recording medium 2.

As shown in FIG. 3, the light receiving/emitting element 4 is equipped with a semiconductor substrate (PDIC substrate) laminated and fixed with a fixing agent such as silver paste onto the surface of the wiring substrate 31, and with first and second laser diode chips 43 and 44 laminated and fixed on to the surface of the semiconductor substrate 41. The first laser diode chip 43 emits a laser beam with a wavelength of 780 nm band, and the second laser diode chip 44 emits a laser beam with a wavelength of 650 nm band.

A light receiving section 45 that detects optical signals, a second light receiving section 451 that detects laser beam output, and a signal processing circuit that processes detected signals obtained by the light receiving section 45 are built on the semiconductor substrate 41. A total reflection mirror 46 that reflects returning light downward and leads it towards the light receiving section 45 is mounted on the part of the surface of the semiconductor substrate 41 where the light receiving section 45 is built. A positioning member 48 is formed adjacent to an area where the first and second laser diode chips 43 and 44 are mounted. The positioning member 48 has three protruding sections 48a, 48b and 48c that regulate the optical axial direction and the direction that is orthogonal to the optical axial direction, and positions the first and second laser diode chips 43 and 44. In addition, laser beam passing grooves 413, that allow laser beams to pass through by preventing the laser beams from being reflected off of the surface of the semiconductor substrate, are carved into the surface of the semiconductor substrate 41.

Next, referring to FIG. 4, the optical system of the optical head apparatus 1 according to the present embodiment will be described. The first optical element 6, the second optical element 7, the collimate lens 8 and the raising mirror 9 are positioned on the light path in the light receiving/emitting element 4 extending from the first and second laser diode chips 43 and 44 to the object lens 10. The first optical element 6 is a wavelength selective hologram element that divides only the laser beam with a wavelength of 780 nm band emitted from the first laser diode chip 43 into three beams. The second optical element 7 is a wavelength selective hologram element that alters the light paths to and fro and it alters the light path of the light returning from the optical recording medium 2 and leads it towards the total reflection mirror 46 of the light receiving/emitting element 4. The raising mirror 9 perpendicularly reflects the emitted laser beam that has been collimated by the collimate lens 8 and leads it towards the object lens 10.

Of the optical parts comprising the optical system, the light receiving/emitting element 4, the first optical element 6, the second optical element 7 and the collimate lens 8 are attached to the component holder 15 that is made of photosensitive glass in a state in which they are positioned with respect to one another. The component holder 15 is mounted on the surface of the wiring substrate 3. The component holder 15 has a flat panel shape with its interior cut out, and positioning end surfaces are formed on the opposing inner sides of a pair of arm frame parts on the right and left sides of the component holder 15. The positioning end surfaces are provided to hold the light receiving/emitting element 4, the first optical element 6, the second optical element 7 and the collimate lens 8 in their respective predetermined positions and in their respective predetermined postures. Position adjustment on the optical parts in the optical axial direction takes place automatically by mounting them on the component holder 15.

In the optical head apparatus 1 thus structured, information reproduction from and information recording to various types of the optical recording medium 2 takes place in the following manner. When reproducing information from the optical recording medium 2 such as a DVD, a light beam with a wavelength of 650 nm band is emitted from the second laser diode chip 44. When information is recorded on the optical recording medium 2 such as a CD-R, a laser beam with a wavelength of 780 nm band is emitted from the first laser diode chip 43.

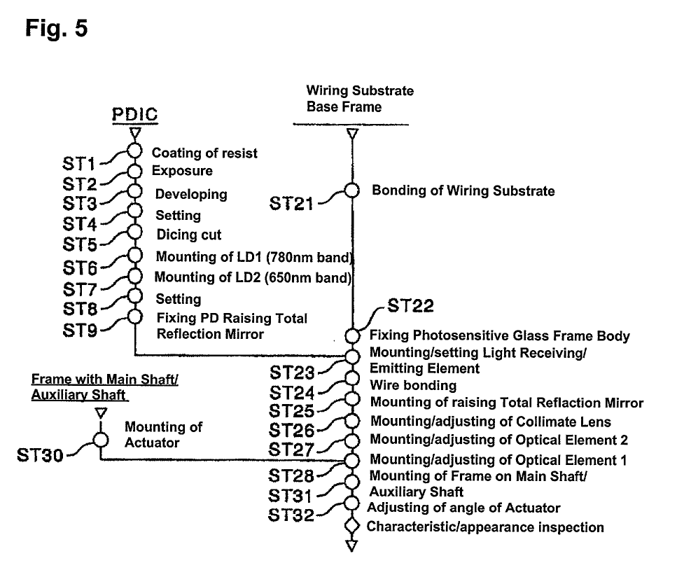

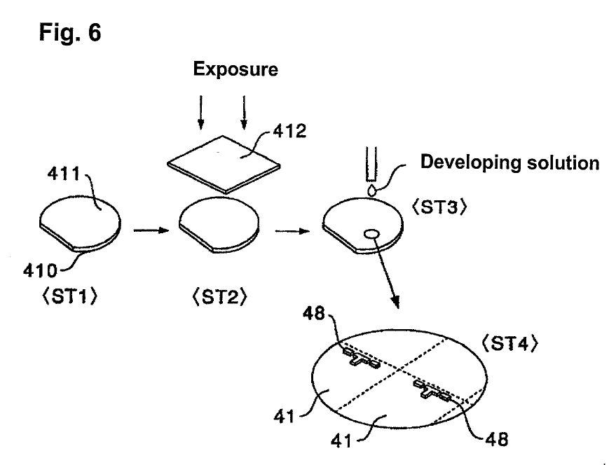

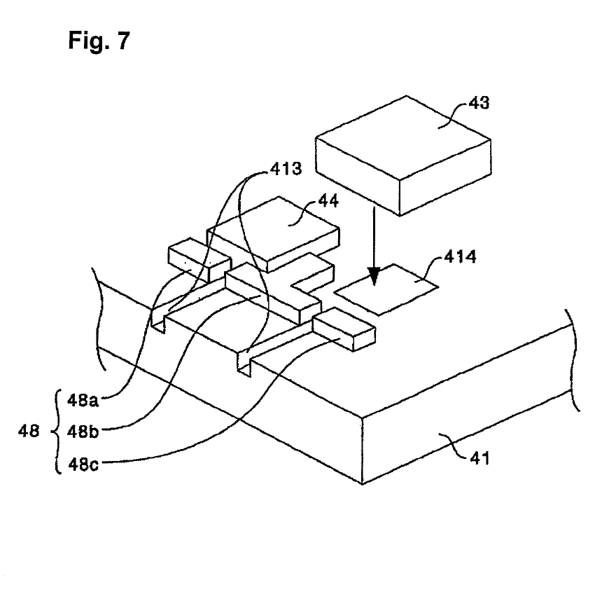

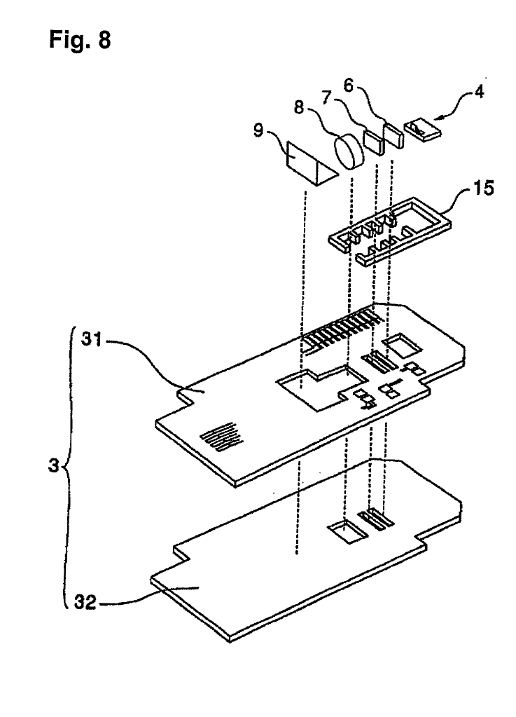

Next, an assembly procedure for assembling the optical head apparatus 1 according to the present embodiment will be described. FIG. 5 is a process flow chart illustrating the assembly procedure for assembling the optical head apparatus 1. FIG. 6 shows a process diagram that illustrate a method for forming a semiconductor laser chip positioning member in the light receiving/emitting element 4 of the optical head apparatus 1. FIG. 7 shows a process diagram that illustrate a method of positioning the semiconductor laser chip in the light receiving/emitting element 4 of the optical head apparatus 1. FIG. 8 is an exploded perspective view showing how optical parts are mounted on the wiring substrate 3 of the optical head apparatus 1.

First, the light receiving/emitting element 4 is manufactured by steps ST1 through ST9 shown in FIG. 5. As shown in FIG. 6, a substrate (wafer) 410 having a plurality of semiconductor substrates 41 formed therein is prepared. Each of the semiconductor substrates 41 has a light receiving section 45 and an integrated circuit built in. The light receiving section 45 receives the light returning from the optical recording medium and detects signal representative of the light received and the integrated circuit that processes the signal representative of the light received. Then, a resist member 411 made of photosensitive polyimide is coated on the wafer 410. The resist member 411 is covered with a photo mask 412 and exposed (step ST1 and step ST2). By developing and setting the exposed resist member 411, the positioning member 48 is formed on each of the semiconductor substrates 41 (step ST3 and step ST4).

The wafer 410 on which a plurality of positioning members 48 is formed is diced into individual chips (step ST5). The positioning member 48 comprising the three protruding sections 48a, 48b and 48c, as shown in FIG. 7, is formed on each of the semiconductor substrates 41 now in chip form. By pressing the first and second laser diode chips 43 and 44 against the positioning member 48 to position them and by heat melting and subsequently setting a fusion-bonding agent 414 preformed on the semiconductor substrate 41, the first and second laser diode chips 43 and 44 are fixed (step ST6, step ST7 and step ST8).

Laser passing grooves 413, which prevent laser beams with predetermined divergence angles from being reflected off of the surface of the semiconductor substrate 41, are formed in the surface of the semiconductor substrate 41 in the direction lasers are emitted from the first and second laser diode chips 43 and 44 thus fixed. The laser beam passing grooves 413 are formed by etching or laser processing during a wafer process in the manufacture of a PDIC substrate.

Next, the mirror 46, a triangular mirror with total reflection mirror surfaces, is mounted, bonded and fixed in a predetermined position on the light receiving section 45, which detects optical signals, of the light receiving/emitting element 4 (step ST9).

In the meantime, in steps ST21 and ST22 of FIG. 5, the wiring substrate 3 having a laminate structure comprising the wiring plate section 31 and the metal base plate section 32 is prepared. The component holder 15, which is a photosensitive glass frame body, is bonded and fixed in its predetermined position on the wiring plate section 31 (step ST22).

The mounting of various components on the wiring substrate 3 as outlined in steps ST23 through ST28 will be explained with reference to FIG. 8.

First, the light receiving/emitting element 4 is positioned and fixed in a position determined by the component holder 15 of the wiring substrate 3. The area on the wiring substrate 3 where the light receiving/emitting element 4 is positioned is an area with an opening in the wiring plate section 31, so that the light receiving/emitting element 4 is fixed with silver paste on the base plate section 32 (step ST23).

Next, electrodes of the elements that are formed on the light receiving/emitting element 4, i.e., the laser diode chips 43 and 44, the light receiving section 45 and the integrated circuit, are electrically connected with electrodes of the wiring substrate 3 by having the two sets of electrodes wire bonded (step ST24).

The first and second optical elements 6 and 7, the collimate lens 8 and the raising mirror 9 are mounted in their respective positions as determined by the component holder 15 and their positions are adjusted. The position adjustment in the tracking direction and/or the focusing direction of the first and second optical elements 6 and 7, which are wavelength selective hologram elements, are done by actually irradiating the first and second optical elements 6 and 7 with laser beams and using the object lens to converge the beams on an optical recording disk. The areas of the wiring substrate 3 where the first and second optical elements 6 and 7 are positioned are through holes, and these through holes are utilized in the position adjustment of the first and second optical elements 6 and 7 that is performed using pins and other tools (step ST25, step ST26, step ST27 and step ST28).

Here, in step ST30, components that comprise the object lens drive mechanism 11 are fixed with adhesive in predetermined positions on the apparatus frame 5.

Next, in step ST31, the wiring substrate 3 on which optical parts are mounted is fixed with screws to the apparatus frame 5, which is mounted on the primary shaft and the secondary shaft of the apparatus main body.

In step ST32, power is fed from a feed connector attached to the wiring panel section 31 to the first and second laser diode chips 43 and 44, the light receiving section 45 and the object lens drive mechanism 11, and the inclination angle of the object lens is adjusted. After adjusting the inclination of the object lens, a resin cover is attached to the part of the top surface of the apparatus frame 5 where the wiring plate section 31 is positioned, and following a property inspection and an appearance inspection the optical head apparatus 1 is completed.

As described above, the optical head apparatus 1 according to the present embodiment has various optical parts such as the light receiving/emitting element 4 mounted on the wiring substrate 3. In contrast, the object lens drive mechanism 11, which is the source of vibration, is mounted on the apparatus frame 5 and attached to the wiring substrate 3 via the apparatus frame 5.

The apparatus frame 5 made of resin functions as a damper member and absorbs the vibration from the object lens drive mechanism 11, and this prevents the vibration from being transmitted to the wiring substrate side and vibrating various optical parts mounted on the wiring substrate. In addition, since the apparatus frame 5 with the primary shaft guide hole and the secondary shaft guide groove on its two ends is used as the damper member in the present embodiment, there is no need to attach a separate damper member. Further, since there is no need to make slits in the wiring substrate in order to prevent vibration from being transmitted, the rigidity of the wiring substrate 3 is not diminished and the wiring pattern area is not reduced.

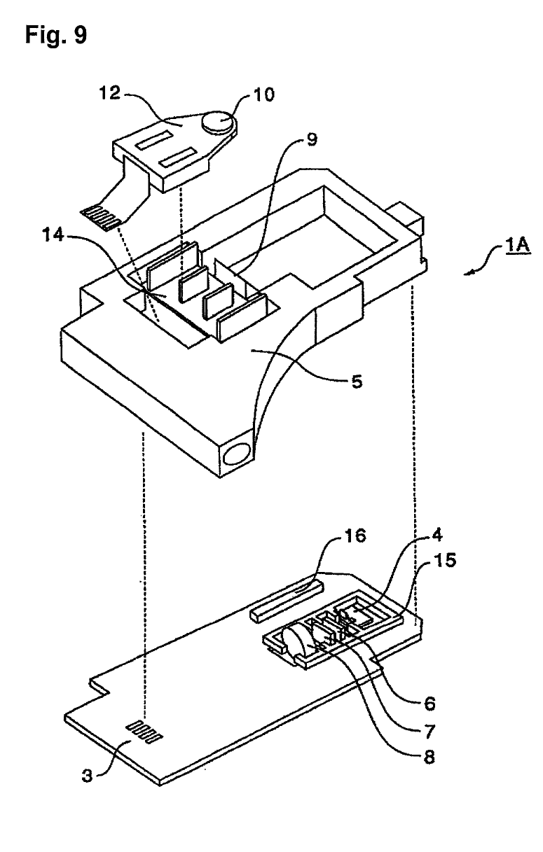

In the optical head apparatus 1 described above, the raising mirror 9 is mounted on the wiring substrate 3 to raise laser beams towards the object lens, but the raising mirror can be mounted on the side of the apparatus frame 5. For example, the raising mirror 9 can be mounted on the apparatus frame 5 as in the case of an optical head apparatus 1A shown in FIG. 9.

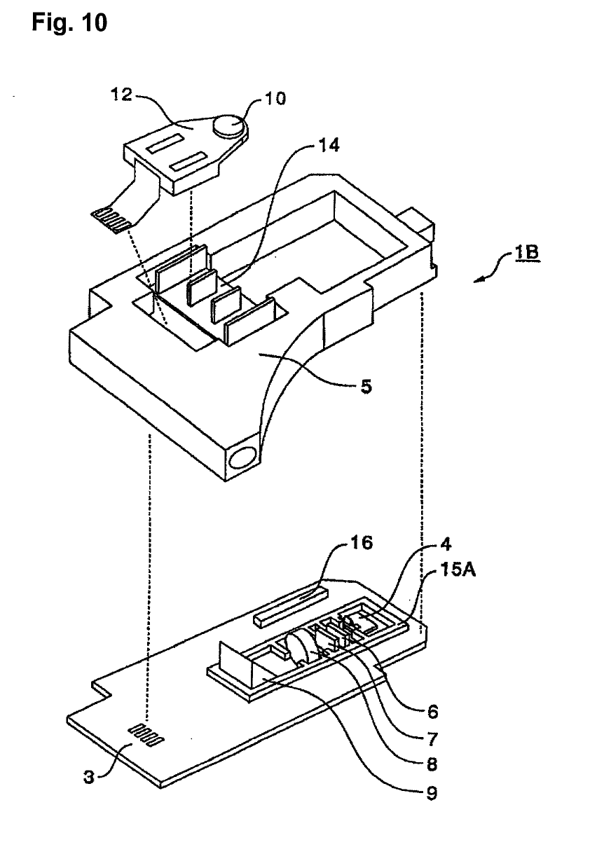

Alternatively, the raising mirror 9 can be mounted on the wiring substrate 3 and at the same time be positioned with a component holder. For instance, the raising mirror 9 can be mounted on the wiring substrate 3 by using a component holder 15A, in which a raising mirror positioning section is formed by extending one end of the component holder 15 in the optical axial direction, as shown in an optical head apparatus 1B in FIG. 10.

In the above embodiment, the wire suspensions 13 and the yoke plate 14 are attached to the wiring substrate 3 via the resin apparatus frame 5 in order to absorb the vibration from the object lens drive mechanism 11, but the interior of the apparatus frame 5 can be cut out to form a vibration absorbing material storage chamber that stores a vibration absorbing material made of gel or fluid resin. When the apparatus is constructed in the manner descried above, the vibration from the object lens drive mechanism 11 can be absorbed through an active damper effect of the absorbing material that vibrates in a phase opposite to that of the vibration of the object lens drive mechanism 11.

As described above, in an optical head apparatus according to the present embodiment, although various optical parts that constitute the optical system of the optical head apparatus are mounted on a wiring substrate, component parts comprising an object lens drive mechanism that is the source of vibration are mounted on the wiring substrate via a damper member. As a result, the vibration generated by the object lens drive mechanism is absorbed by the damper member, whereby the various optical parts mounted on the wiring substrate are securely prevented from vibrating, and the deterioration of optical properties resulting from the vibration can be avoided.

Further in the present invention, a apparatus frame with a primary shaft guide hole and a secondary shaft guide groove formed on its two ends is used as the damper member. As a result, there is no need to attach a separate damper member, which presents no hindrance to the effort to make the optical head apparatus thinner.

Moreover, since there is no need to form slits on the wiring substrate in order to prevent the vibration from being transmitted, the rigidity of the wiring substrate is not diminished and the wiring pattern area is not reduced.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical head apparatus comprising:
a wiring substrate;
an optical system having a plurality of optical components, the optical system being mounted on the wiring substrate;
an object lens drive mechanism; and
a damper member holding the object lens driving mechanism, wherein the damper member is attached to the wiring substrate such that the wiring substrate is connected to the object lens driving mechanism through the damper member.

2. An optical head apparatus according to claim 1, further comprising a component holder that retains the plurality of optical components of the optical system, wherein the component holder is attached to the wiring substrate.

3. An optical head apparatus according to claim 1, wherein the damper member is an apparatus frame equipped with a bearing section that allows linear movements of the optical head apparatus in a specified direction.

4. An optical head apparatus according to claim 3, wherein the apparatus frame is made of resin.

5. An optical head apparatus according to claim 3, wherein the apparatus frame is equipped with a vibration absorbing material storage section and a vibration absorbing material that is stored in the vibration absorbing material storage section.

6. An optical head apparatus according to claim 4, wherein the apparatus frame has a cut out section, and the object lens drive mechanism is mounted generally inside the cut out section of the apparatus frame.

7. An optical head apparatus according to claim 4, wherein the object lens drive mechanism includes a yoke with a driving magnet and a lens holder with a driving coil that is moveable by magnetic force of the driving magnet, wherein the lens holder is supported by a holder support member that is connected to an inner sidewall of the cut out section of the apparatus frame.

8. An optical head apparatus comprising:
a lens holder to hold an object lens;
a holder support member that supports the lens holder in a manner movable in at least one of a focusing direction and a tracking direction;
an optical system that includes a plurality of optical parts including at least a light source and a light receiving element, wherein the optical system leads light emitted from the light source towards the object lens while also leading returning light towards the light receiving element;
a wiring substrate including a power feed wiring pattern for the light source and for the light receiving element; and
a damper member disposed between the holder support member and the wiring substrate, wherein the light source, the light receiving element, and at least one of the optical parts are mounted on the wiring substrate, and the holder support member is attached to the wiring substrate via the damper member.

9. An optical head apparatus according to claim 8, wherein the damper member is an apparatus frame equipped with a bearing section that allows linear movements of the optical head apparatus in a specified direction.

10. An optical head apparatus according to claim 9, wherein the apparatus frame is made of resin that substantially absorb vibrations generated by the holder support member.

11. An optical head apparatus according to claim 9, wherein the apparatus frame has a cut out section, and the holder support member is mounted generally inside the cut out section of the apparatus frame.

12. An optical head apparatus according to claim 9, wherein the lens holder is supported by a holder support member that is connected to an inner sidewall of the cut out section of the apparatus frame.

13. An optical head apparatus according to claim 9, wherein the holder support member includes an object lens drive mechanism having a yoke with a driving magnet, and the lens holder includes a driving coil that is moveable by magnetic force of the driving magnet, wherein the yoke with the driving magnet is mounted generally inside the cut out section of the apparatus frame, and the lens holder is supported by a holder support member that is connected to an inner sidewall of the cut out section of the apparatus frame.

14. An optical head apparatus according to claim 13, wherein the holder support member comprises a wire suspension device that moveably supports the lens holder in a cantilever fashion.

15. An optical head apparatus comprising:
an optical system that includes a plurality of optical parts including at least a light source and a light receiving element, wherein the optical system guides light emitted from the light source towards the object lens while also guiding returning light towards the light receiving element;
a component holder for holding the plurality of optical parts including the light source and the light receiving element;
a wiring substrate including a power feed wiring pattern for the light source and for the light receiving element, wherein the component holder that holds the plurality of optical parts including the light source and the light receiving element is mounted on the wiring substrate;
a holder support mechanism for driving a lens holder holding an object lens; and
a resin frame member that fixedly retains the holder support mechanism and moveably supports the lens holder in at least one of a focusing direction and a tracking direction.

16. An optical head apparatus according to claim 15, wherein the resin frame has a cut out section, and the holder support mechanism is mounted generally inside the cut out section of the resin frame.

17. An optical head apparatus according to claim 15, wherein the lens holder is supported by a resilient holder support member that is connected to the resin frame.

18. An optical head apparatus according to claim 15, wherein the lens holder is supported by a resilient holder support member that is connected to an inner sidewall of the cut out section of the resin frame.

19. An optical head apparatus according to claim 15, wherein the holder support mechanism includes a yoke with a driving magnet, and the lens holder includes a driving coil that is moveable by magnetic force of the driving magnet, wherein the yoke with the driving magnet is fixed attached to an inside of the cut out section of the resin frame, and the lens holder is resiliently supported by a holder support member that is connected to an inner sidewall of the cut out section of the apparatus frame.
